(19) United States
(12) Patent Application Publication
(10) Pub. No.: US 2006/0251283 A1
(43) Pub. Date: Nov. 9, 2006

(54) Bag type earphone structure

(76) Inventor: Ming-Hsiang Yeh, Taipei City (TW)

Correspondence Address: TROXELL LAW OFFICE PLLC, SUITE 1404, 5205 LEESBURG PIKE, FALLS CHURCH, VA, 22041, US

(21) Appl. No.: 11/120,976

(22) Filed: May 4, 2005

(51) Int. Cl. H04R 1/00

(52) U.S. Cl. 381/388; 381/385

(57) ABSTRACT

A bag type earphone structure comprises a main body having a storage bag for holding the article, particularly an electronic product for playing and transmitting the sound. An earphone is movably mounted inside the main body. When the electronic device is mounted inside the storage bag, the main body can be attached to a portion or an accessory nearest the ear for playing the content of the electronic product to the user through the earphone. Accordingly, the user is protected from interference by the earphone wires. If there is no need to use the earphone, the earplugs can be held on the edge of the main body.

### FIELD OF THE INVENTION

The present invention relates to a bag type earphone structure, and more particularly to a structure suitable for holding an electronic product such as a MP3 player, a radio, a mobile phone, or the like for playing and transmitting the sound.

### BACKGROUND OF THE INVENTION

In recent years, all kinds of portable products such as mobile phones, Walkmans, and MP3 players are very popular. In order to facilitate the walking of the user or not to hinder the user from driving the car, the earphone or the hand-free headset is adopted. However, the conventional hand-free headset includes a long string of earplugs, a microphone, a clip, earphone wires, and an earphone plug. When it is in use, the earphone wires are easy to be shaken, hooked, or wound. Accordingly, the conventional hand-free headset is very inconvenient in use.

Although the mobile phone and MP3 player are also provided with a storage box or a necklace to enable the user to hang them on the lumbar region or the neck, the storage box is designed merely for holding the mobile phone and the MP3 player, not for holding the earphone and the hand-free headset. The earphone and the hand-free headset are provided with no fixed storage location. Accordingly, the inconvenient carrying and the disordered storage and mounting occur when the earphone and the hand-free headset are not in use.

In view of the drawback of the conventional structure, the present inventor makes diligent researches with a quiet mind to provide a bag type earphone structure for the consumer in accordance with the motive of the present invention. Accordingly, when the earphone is not in use, the earplugs can be held conveniently.

### SUMMARY OF THE INVENTION

It is a main object of the present invention to provide a bag type earphone structure for holding an article, particularly an electronic product for playing and transmitting the sound.

It is another object of the present invention to provide a bag type earphone structure that can be attached to a random position in accordance with the user's selection.

It is a further object of the present invention to provide a bag type earphone structure that prevents the earphone wires from interference with the user.

In order to achieve the aforementioned object, a bag type earphone structure of the present invention comprises a main body having a storage bag for holding the article, particularly an electronic product for playing and transmitting the sound. An earphone is movably mounted inside the main body. When the electronic device is mounted inside the storage bag, the main body can be attached to a portion or an accessory nearest the ear for playing the content of the electronic product to the user through the earphone. Accordingly, the user is protected from interference by the earphone wires. If there is no need to use the earphone, the earplugs can be held on the edge of the main body.

The aforementioned aspects and advantages of the present invention will be readily clarified in the description of the preferred embodiments and the enclosed drawings of the present invention.

### BRIEF DESCRIPTION OF THE DRAWINGS

FIG. 1 is an elevational view of a first preferred embodiment of the present invention.

FIG. 2 is a schematic view showing the usage of the earphone of the first preferred embodiment of the present invention.

FIG. 3 is another schematic view showing the usage of the earphone of the first preferred embodiment of the present invention.

FIG. 4 is an elevational view of a second preferred embodiment of the present invention.

FIG. 5 is a schematic view showing the usage of the second preferred embodiment of the present invention.

FIG. 6 is an elevational view of a third preferred embodiment of the present invention.

FIG. 7 is a schematic view showing the usage of the third preferred embodiment of the present invention.

FIG. 8 is another schematic view showing the usage of the third preferred embodiment of the present invention.

FIG. 9 is a schematic view showing another usage of the third preferred embodiment of the present invention:

### DETAILED DESCRIPTION OF THE PREFERRED EMBODIMENT

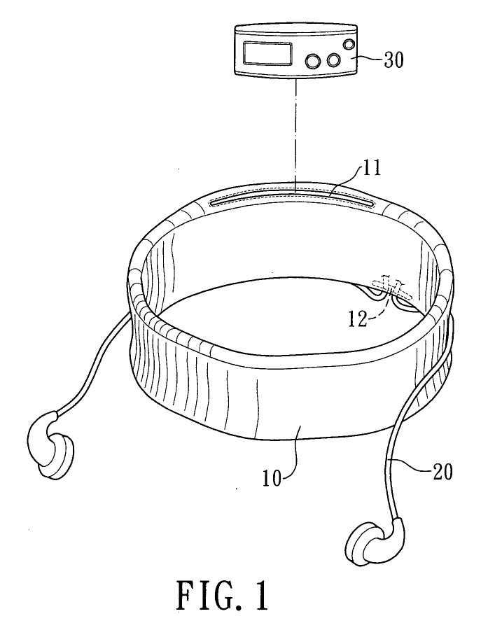

Referring to FIG. 1, a first preferred embodiment of the present invention is shown. An elastic belt 10, which is made of elastic textile fabric, is provided for being tied to the head, the neck, the arm, the thigh, or the carrier bag. A storage bag 11 is formed in the elastic belt 10. A hole 12 is formed on the edge of the storage bag 11. An earphone 20 having two earplugs is movably mounted in the elastic belt 10, and the earplugs are exposed to the outside of the elastic belt 10 through the hole 12.

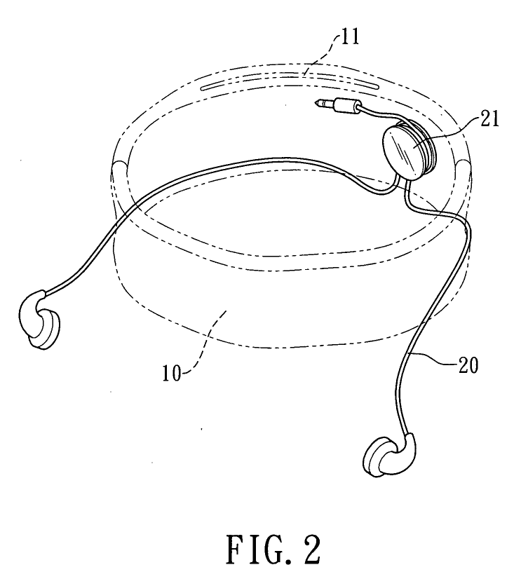

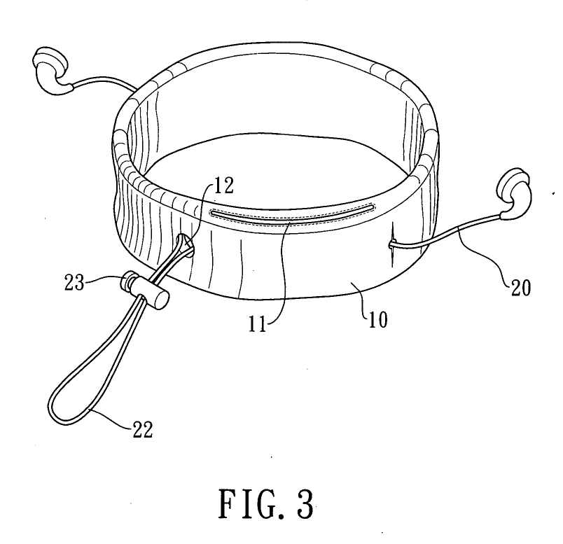

The earphone 20, which is movably mounted in the elastic belt 10, is, for example, in the form as shown in FIG. 2. A transmission device is connected to one end of the earphone 20, and the transmission device is a wired earphone plug or a wireless Bluetooth chip module. Besides, a winding reel 21 is mounted on the backside of the transmission device for winding two earphone wires to which the earplugs are connected. When these two earplugs are pulled by external force, the winding reel 21 releases the earphone wires, which are wound in the winding reel 21. If there is no need to use the earplugs, the earplugs are pulled again to allow the winding reel 21 to roll up the earphone wires, and thereby avoid the incapability of rolling up the earphone wires for preventing the earphone wires from exposing to the outside. Referring to FIG. 3, another example of winding the earphone wires is shown. In this figure, the transmission device of the earphone 20 is connected directly to two earphone wires to which the earplugs are connected, and two ends of a rope 22 by which a stopper 23 is pierced through are connected to these two earphone wires to which the earplugs are connected. Accordingly, the rope 22 is pulled or released by pressing or releasing the stopper 23 to wind or release the earphone 20.

When it is in the use, the electronic product such as the mobile phone or the MP3 player is mounted inside the storage bag 11 of the elastic belt 10 for transmitting and playing the sound signal. If the electronic product is equipped with the wireless transmitter, the electronic product can be put into the storage bag 11 directly 11. If the electronic product is not equipped with the wireless transmitter, the earphone plug is inserted into an earphone jack of the electronic product. The illustrated electronic product in this preferred embodiment is the MP3 player 30. Next, the elastic belt 10 is tied to the head, and the earplugs, which are exposed to the outside of the elastic belt 10 through the hole 12, are pulled down so that the earphone 20 can touch the ear by shortest distance. When there is no need to use the earphone 20, the electric power of the MP3 player 30 is turned off. Thereafter, the external force is applied to the earplugs again or the rope 22 is pulled back directly, and the stopper 23 is pressed or shifted to position the rope 22 such that the earphone wires can be gathered together efficiently to prevent the earphone wires from interference with the user.

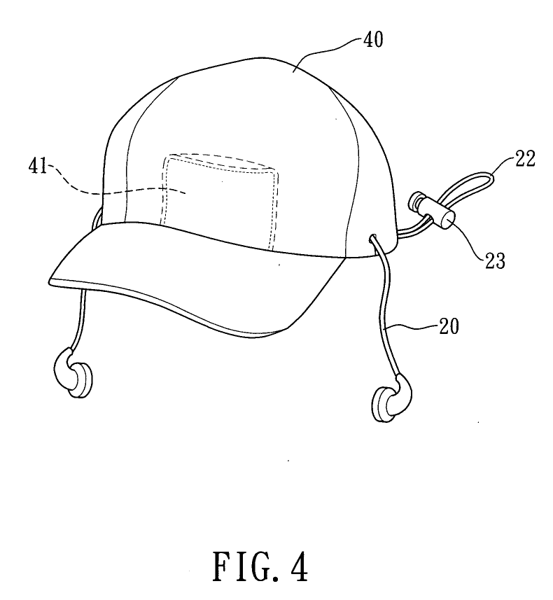

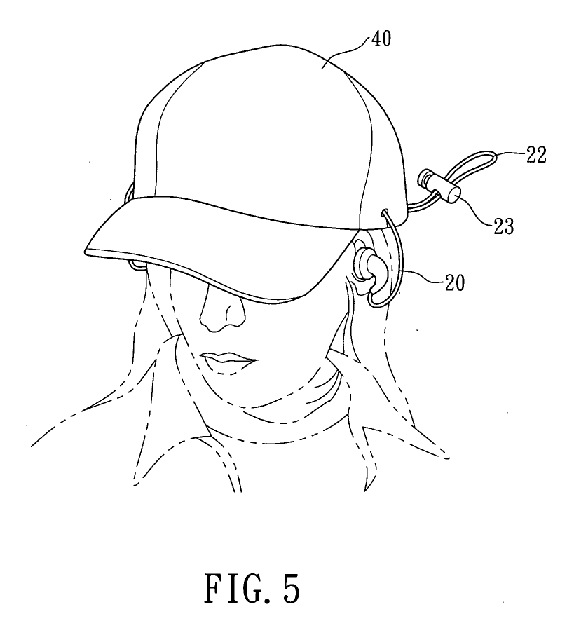

FIG. 4 shows a second preferred embodiment of the present invention. There are several kinds of hats such as the leisure straw hat, the army cap, the safety helmet, the baseball cap, etc. In this preferred embodiment, the most commonly seen baseball cap 40 is illustrated for exemplification. A storage bag 41 is mounted on the inner edge or the outer edge of the baseball cap 40, and an earphone 20 is movably mounted on the inner edge of the baseball cap 40. A transmission device is connected to one end of the earphone 20, and the transmission device is a wired earphone plug or a wireless Bluetooth chip module. The other side of the transmission device is identical to that shown in FIG. 2 and FIG. 3, in which a winding reel 21 or a combination of rope 22 and stopper 23 is applied to the ends of the earphone wires to which the earplugs are connected. In this preferred embodiment, the rope 22 and the stopper 23 are illustrated for exemplification. These two earphone wires of the earphone 20 are oppositely mounted on both sides of the baseball cap 40, respectively. These two earphone wires are connected to two ends of the rope 22 by which the stopper 23 and the hole formed on the backside of the baseball cap 40 are pierced through. The MP3 player 30 is connected to the transmission device of the earphone 20 and mounted inside the storage bag 41 such that when the baseball cap 40 is worn on the head, as shown in FIG. 5, the earplugs, which are oppositely mounted on the bottom edge of the cap, can be pulled down and inserted into the ears by shortest distance. Accordingly, when the user is in motion, the user is protected from interference by the earphone wires. If there is no need to use the MP3, the exposed length of the earphone wires can be shortened by merely pulling back the rope 22. After that, the stopper 23 are pressed and shifted simultaneously to fix the earplugs such that the earplugs are prevented from glide for facilitating the storage of the earphone 20.

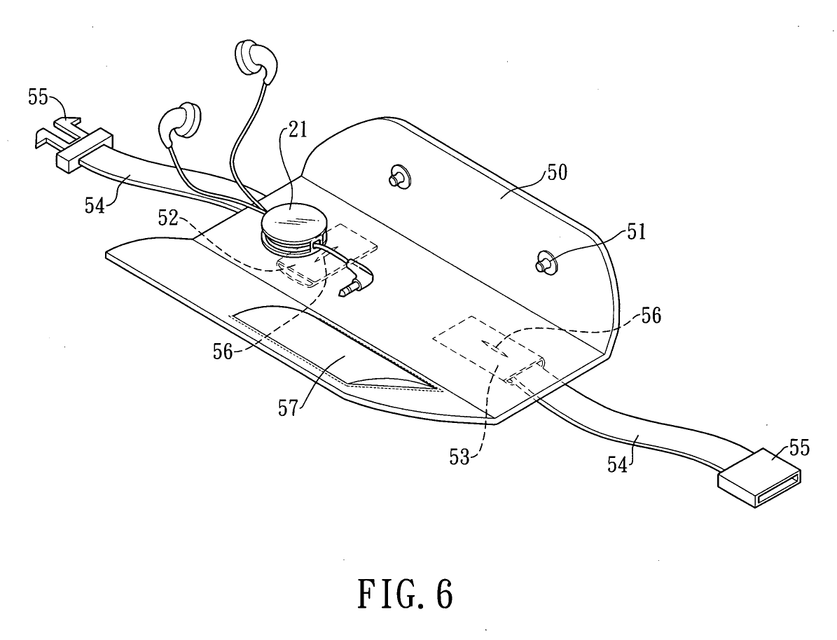

Referring further to FIG. 6, a third preferred embodiment of the present invention is shown. A plate 50 is provided, and two connection parts 51 are mounted respectively on two opposite sides of the plate 50 for being coupled to one another when the plate 50 is folded up into a bag. Two rings 52 and 53, which are perpendicular to one another, are mounted on the outer edge of the plate 50 for being pierced by an adjustable belt 54 having connection buckles 55 at its ends. Besides, buckle holes 56 are formed respectively on the rings 52 and 53. An earphone 20 is movably mounted inside the plate 50 and a pocket 57 is formed inside the plate 50. A transmission device such as a wired earphone plug or a wireless Bluetooth chip module is connected to one end of the earphone 20. The earphone wires are connected to the other end of the earphone 20. Besides, a winding reel 21 is mounted between the transmission device and the earphone wires, as shown in FIG. 2. Alternatively, the earphone wires are connected to the transmission device directly, and the earphone wires are further connected to two ends of the rope 22, which pierce through the stopper 23, as shown in FIG. 3.

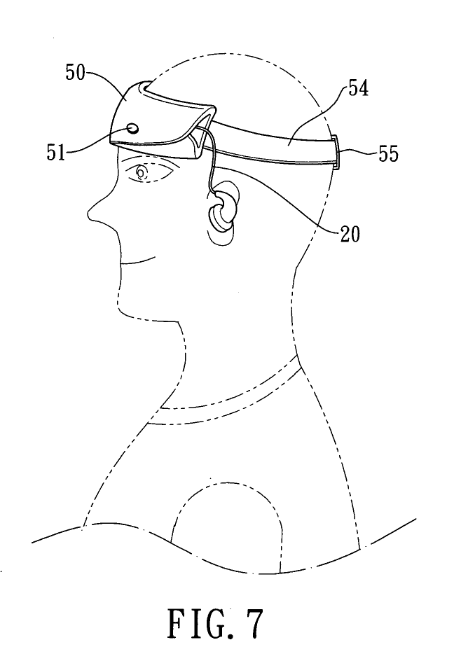

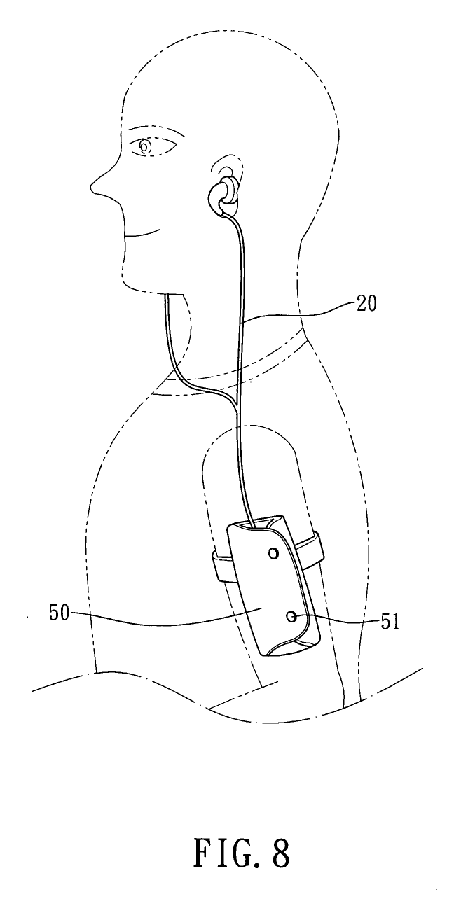

After the MP3 player 30 is coupled with the transmission device of the earphone 20, it is put into the plate 50 or the pocket 57. The plate 50 is then folded up to form the bag for wrapping the MP3 player 30. If the user wants to tie the bag to the forehead, as shown in FIG. 6 and FIG. 7, the length of the adjustable belt 54 is then adjusted for directly piercing the adjustable belt 54 through the ring 52 so that the bag is horizontally mounted on the forehead. Thereafter, the earplugs are pulled out from both sides to facilitate the insertion of the earplugs into the ears for enjoying the music. If the user wants to tie the bag to the arm, as shown in FIG. 8, he also needs to adjust the length of the adjustable belt 54. In this case, the adjustable belt 54 is designed to pierce trough the ring 53 so that the bag can be vertically connected to the arm. Moreover, the earplugs are pulled out from the same side to facilitate the insertion of the earplugs into the ears.

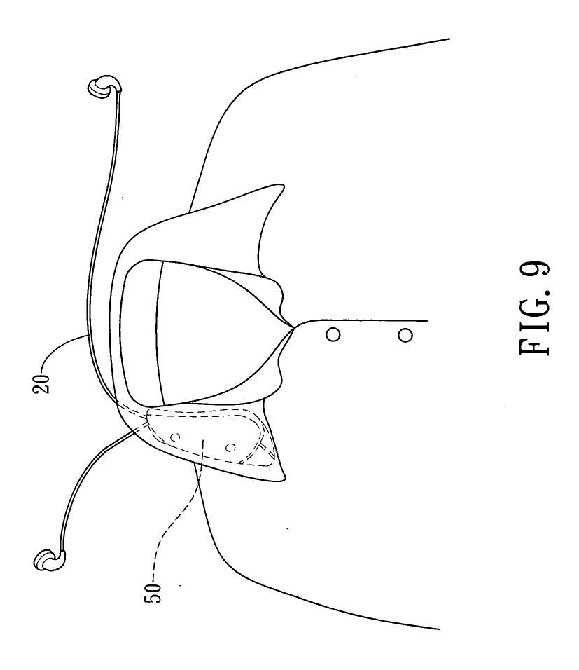

Furthermore, the adjustable belt 54 can be removed by pulling it out fully. The buckle holes 56, which are formed on the rings 52 and 53, can be buckled to the buttons, which are mounted on the neckband or the shoulder of the shirt. Accordingly, the MP3 player 30 is coupled to the bag, which is formed by the plate 50, and can be mounted on the shoulder or hidden below the neckband, as shown in FIG. 9, to allow the earphone 20 to contact the ears by the shortest distance. Besides, the power of the earphone 20 can be increased or the volume of the MP3 player 30 can be adjusted to allow the earphone 20 to form a little speaker so there is no need to insert the earplugs into the ears. Accordingly, the motion of the user is protected from interference by the earphone wires, and the burden of inserting the foreign matter into the ear is also lightened.

From the aforementioned description, it is apparent that the present invention provides the following practical advantages, in which:

1. An earphone, which facilitates the winding of the earphone wires, is movably mounted inside the main body near the storage bag into which article, especially such as the electronic product, for playing and transmitting the sound is mounted for transmitting the sound through the earphone. The earphone wires can be conveniently stored in the edge of the main body when it is not in use.

2. The main body of the storage bag enables the user to attach it to a portion or an article nearest the ear such that the earplugs can be inserted into the ears by the shortest distance. Accordingly, the storage bag facilitates the carrying of the earphone, and its major feature consists in that the motion of the user is protected from interference by the earphone wires.

3. The earphone is movably mounted inside the main body of the storage bag so the earphone can be then detached from the main body to facilitate the cleaning of the main body when it gets dirty.

4. The power of the earphone can be increased or the volume of the MP3 player can be adjusted to allow the earphone to form a little speaker so there is no need to insert the earplugs into the ears. Accordingly, it lightens the burden on the ears.

On the basis of the aforementioned description, it is apparent that the present invention can achieve the expected purposes. The present invention satisfies all requirements for a patent and is submitted for a patent.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

What the invention claimed is:

1. A bag type earphone structure, comprising:
a main body having a storage bag;
an earphone movably mounted inside the main body;
a transmission device connected to one end of the earphone at the edge of the storage bag; and
two earplugs connected to the other end of the earphone for being exposed to the outside of the main body such that when an electronic device for playing and transmitting the sound is mounted inside the storage bag, the main body can be attached to a portion or an accessory nearest the ear to prevent earphone wires of the earphone from interference with the user during the use of the earphone and to facilitate the storage of the earplugs on the edge of the main body if there is no need to use the earphone.

2. The bag type earphone structure of claim 1, wherein the main body is an elastic belt made of elastic textile fabric.

3. The bag type earphone structure of claim 1, wherein the main body is a hat and the storage bag is mounted on the inside or the outside of a hat body of the hat.

4. The bag type earphone structure of claim 1, wherein the main body is a plate, which can be folded up into a bag form, and the main body further comprises: two connection parts mounted oppositely on two sides of the plate; at least a ring mounted on the outside of the plate; an adjustable belt having connection buckles; a pocket formed inside the plate; and the earphone movably mounted inside the plate such that the plate can be folded up and fixed by the connection parts to put the earphone into the folded plate and that the plate can be attached to a random position by piercing the adjustable belt through the ring.

5. The bag type earphone structure of claim 4, wherein two rings, which are perpendicular to one another, are mounted on the outside of the plate such that the adjustable belt can select the horizontal or vertical direction to pierce through the folded plate.

6. The bag type earphone structure of claim 4, wherein the rings mounted on the outside of the plate further comprises buckle holes formed thereon.

7. The bag type earphone structure of claim 1, wherein the transmission device is a wired earphone plug or a wireless Bluetooth chip module.

8. The bag type earphone structure of claim 1, wherein the earphone wires to which the earplugs are connected is connected to the transmission device through a winding reel.

9. The bag type earphone structure of claim 1, wherein the earphone wires to which the earplugs are connected is connected to the transmission device directly and two ends of a rope by which a stopper is pierced through are connected to the earphone wires.
